(19) United States
(12) Patent Application Publication
(10) Pub. No.: US 2013/0067278 A1
(43) Pub. Date: Mar. 14, 2013

(54) TESTING DEVICE, SWITCHING SYSTEM AND SWITCHING METHOD

(71) Applicants: BING ZHOU, Shenzhen City (CN); DONG-YAN LI, Shenzhen City (CN)

(72) Inventors: BING ZHOU, Shenzhen City (CN); DONG-YAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/463,868

(22) Filed: May 4, 2012

(30) Foreign Application Priority Data
Sep. 9, 2011 (CN) 201110267030.5

(51) Int. Cl. G06F 11/273

(52) U.S. Cl. 714/27; 714/E11.17

(57) ABSTRACT

A testing device communicating with an input device is capable of executing a plurality of programs. The testing device includes a displaying unit, a detecting unit, and a judging unit. The displaying unit displays the working windows of the executing program in an overlapping manner. The detecting unit detects whether a controlling signal corresponding to a predetermined program of the testing device is received from the input device. The judging unit judges whether the working window of the predetermined program is the top-level working window in response to the controlling signal and switches the working window of the predetermined program to be the top-level working window when the working window of the predetermined program is not the top-level working window.

### BACKGROUND

1. Technical Field

The present disclosure relates to switching systems, and particularly to a switching system with a testing device and an input device.

2. Description of Related Art

In computerized testing process, a plurality of testing programs will be executed to test different functions of the electronic device. The display windows of the testing programs are generally displayed in an overlapping manner. When switching the top-level working window, the user needs to manually switch from one window to the next for testing different functionalities of the electronic device. The user may need to switch windows using shortcuts formed with two or more combined buttons of a keyboard or clicking the mouse, which is inconvenient and time-consuming.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of the switching system in accordance with one embodiment.

FIG. 2 is a flowchart of a switching method in accordance with one embodiment.

### DETAILED DESCRIPTION

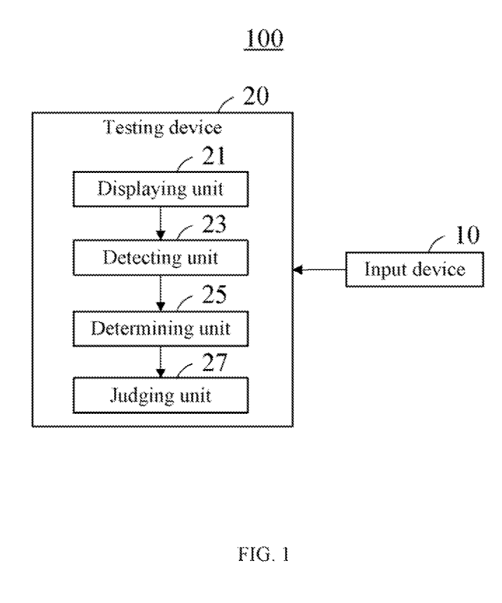

FIG. 1, shows a switching system 100 including an input device 10 and a testing device 20. The testing device 20 is capable of executing a plurality of programs for testing different functions of the electronic device. The input device 10 generates controlling signals in response to user's operation. Each controlling signal generated by the input device 10 corresponds to a predetermined testing program for testing a predetermined function. The switching system 100 is capable of switching a working window of an executing predetermined testing program of the testing device 20 to be the top-level working window when the controlling signal corresponding to the executing predetermined testing program is received. The input device 10 can communicate with the testing device 20 in a wireless manner or a wired manner.

The input device 10 generates controlling signals in response to user's operation and transmits the controlling signals to the testing device 20. The input device 10 defines a plurality of buttons corresponding to different controlling signals when pressed. In one embodiment, the input device 10 can be a keyboard or scanning machine and so on.

The testing device 20 arranges all the working windows of the executing testing programs in an overlapping manner simultaneously. One of the working windows of the executing programs is an top-level working window. The testing device 20 receives the controlling signal from the input device 10 and switches the working window of the executing predetermined testing program to be the top-level working window corresponding to the received controlling signal. In the embodiment, the testing device 20 is a computer and communicates with the input device 10 in a wireless manner. The testing device 20 includes a displaying unit 21, a detecting unit 23, a determining unit 25, and a judging unit 27.

The displaying unit 21 displays all the working windows of the executing testing programs in an overlapping manner.

The detecting unit 23 detects whether a controlling signal from the input device 10 is received and generates a determining signal when a controlling signal from the input device 10 is received.

The determining unit 25 determines whether the predetermined testing program corresponding to the received controlling signal is executed according to the determining signal and generating a judging signal when the predetermined testing program corresponding to the received controlling signal is determined to be executed.

The judging unit 27 judges whether the working window of the predetermined testing program corresponding to the received controlling signal is the top-level working window according to the judging signal and switches the working window of the predetermined testing program corresponding to the received controlling signal to be the top-level working window when the working window of the predetermined testing program corresponding to the received controlling signal is not the top-level working window.

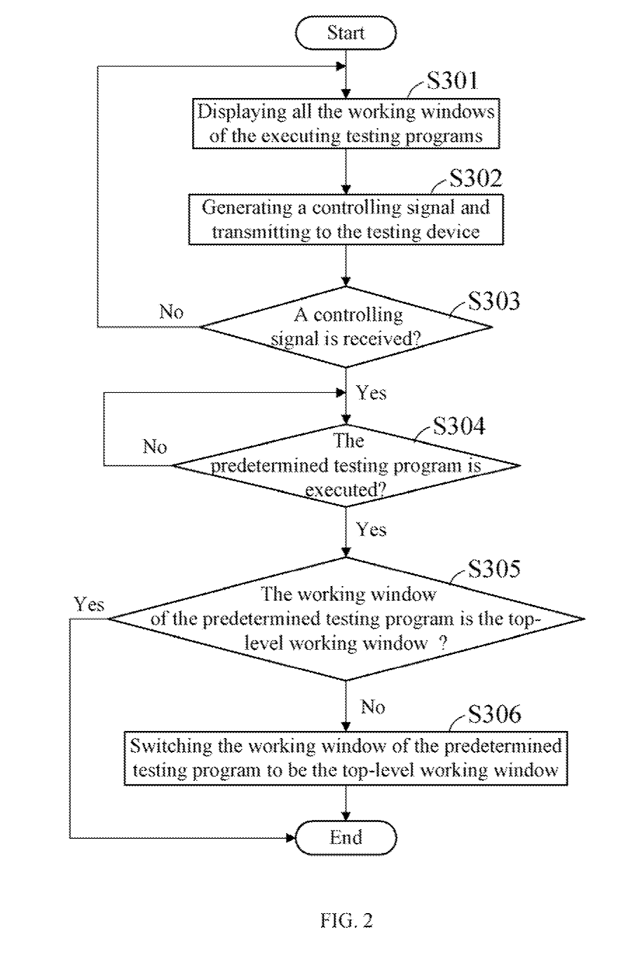

Referring to FIG. 2, a switching method is used for switching a working window of an executing predetermined testing program to be the top-level working window corresponding to a received controlling signal from the input device 10. The testing device 20 is capable of executing a plurality of testing programs. The input device 10 generates controlling signals in response to the user's operation. Each controlling signal generated by the input device 10 corresponds to a predetermined testing program of the testing device 20. The switching method includes the following steps.

In step S301, the display unit 21 displays all the working windows of the executing programs in an overlapping manner and the procedure goes to step S302.

In step S302, the input device 10 generates a controlling signal according to user's operation and transmits the controlling signal to the testing device 20. In the embodiments, the input device 10 defines a plurality of buttons corresponding to different controlling signals when being pressed. In one embodiment, the input device 10 can be keyboard or scanning machine and so on.

In step S303, the detecting unit 23 detects whether a controlling signal from the input device 10 is received. If a controlling signal from the input device 10 is received, the detecting unit 23 generates a determining signal and the procedure goes to step S304; if no controlling signal from the input device 10 is received, the procedure returns to step S301.

In step S304, the determining unit 25 determines whether the predetermined testing program corresponding to the received controlling signal is executed. In the embodiment, if the predetermined testing program corresponding to the received controlling signal is determined to be executed, the determining unit 25 generates a judging signal and the procedure goes to S305; if the predetermined testing program corresponding to the received controlling signal is not executed, step S304 is repeated.

In step S305, the judging unit 27 judges whether the working window of the predetermined testing program corresponding to the received controlling signal is the top-level working window according to the judging signal. In the embodiment if the working window of the predetermined testing program corresponding to the received controlling signal is not the top-level working window, the procedure goes to S306; if the working window of the predetermined testing program corresponding to the received controlling signal is the top-level working window, the procedure ends.

In step S306, the judging unit 27 switches the working window of the predetermined testing program corresponding to the received controlling signal to be the top-level working window.

As described, the testing device 20 switches the working window of the predetermined testing program corresponding to the received controlling signal by the pressed button of the input device 10 to be the top-level working window.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A testing device communicated with an input device and capable of executing a plurality of programs corresponding to a plurality of working windows on the testing device, one of the working windows of the executing programs is a top-level working window, the testing device comprising:
a displaying unit configured to simultaneously display all the working windows of the executing programs in an overlapping manner;
a detecting unit configured to detect whether a controlling signal, corresponding to a predetermined program of the testing device, is received from the input device; and
a judging unit configured to judge whether the working window of the predetermined program is the top-level working window in response to the controlling signal, and switch the working window of the predetermined program to be the top-level working window when the working window of the predetermined program is not the top-level working window.

2. The testing device of claim 1, further comprising a determining unit, wherein the determining unit determines whether the predetermined program is executed and generates a judging signal when the predetermined program is executed.

3. The testing device of claim 1, wherein the testing device communicates with the input device in a wireless manner.

4. The testing device of claim 1, wherein the executing programs of the testing device are used for testing different functions of the electronic device.

5. A switching system comprising:
an input device configured to generate a controlling signal corresponding to a predetermined program corresponding to a plurality of working windows on the testing device in response to a user's operation, one of the working windows of the executing programs is an top-level working window;
a testing device capable of executing a plurality of programs and receiving a controlling signal from the input device, the testing device comprising:
a displaying unit configured to simultaneously display all the working windows of the executing programs in an overlapping manner;
a detecting unit configured to detect whether the controlling signal is received from the input device; and
a judging unit configured to judge whether the working window of the predetermined program is the top-level working window in response to the controlling signal and switch the working window of the predetermined program to be the top-level working window when the working window of the predetermined program is not the top-level working window.

6. The switching system of claim 5, wherein the testing device further comprises a determining unit, the determining unit determines whether the predetermined program is executed and generates a judging signal when the predetermined program is executed.

7. The switching system of claim 5, wherein the testing device communicates with the input device in a wireless manner.

8. The switching method of claim 5, wherein the executing programs of the testing device are used for testing different functions of the electronic device.

9. A switching method between an input device and a testing device which is capable of executing a plurality of programs, each executing program is corresponding to a predetermined working window and one of the working windows of the executing programs is an top-level working window; the switching method comprising:
displaying all the working windows of the executing programs in an overlapping manner;
generating a controlling signal corresponding to a predetermined program of the testing device in response to a user's operation of the input device and transmitting the controlling signal to the testing device;
detecting whether the controlling signal is received from the input device;
judging whether the working window of the predetermined program is the top-level working window in response to the controlling signal; and
switching the working window of the predetermined program to be the top-level working window when the working window of the predetermined program is not the top-level working window.

10. The switching method of claim 9, before the step of judging whether the working window of the predetermined program is the top-level working window in response to the controlling signal further comprising:
determining whether predetermined program is executed and generating a judging signal when the predetermined program is executed.

11. The switching method of claim 9, wherein the testing device communicates with the input device in a wireless manner.

12. The switching method of claim 9, wherein the executing programs of the testing device are used for testing different functions of the electronic device.
